(19) United States
(12) Patent Application Publication
(10) Pub. No.: US 2026/0305515 A1
(43) Pub. Date: Oct. 8, 2026

(54) A METHOD FOR CULTIVATING A PIECE OF FARMLAND, AND A METHOD AND SYSTEM FOR GENERATING A CULTIVATION PLAN

(71) Applicant: AGXEED HOLDING B.V., Grubbenvorst (NL)

(72) Inventors: Joris Jan Hiddema, Grubbenvorst (NL); Laurentius Hubertus Margaretha Schmitz, Mariahoop (NL)

(21) Appl. No.: 19/479,607

(22) PCT Filed: May 21, 2024
(86) PCT No.: PCT/NL2024/050257

§ 371 Date: Oct. 28, 2025

(30) Foreign Application Priority Data
May 22, 2023 (NL) 2034872

(51) Int. Cl. A01B 69/04; G05D 1/229; G05D 1/648; G05D 105/15; G05D 107/20; G05D 109/10

(52) U.S. Cl. CPC A01B 69/008; G05D 1/2295; G05D 1/6484; G05D 2105/15; G05D 2107/21; G05D 2109/10

(57) ABSTRACT

A method for cultivating a piece of farmland within an outer boundary thereof using an autonomous agricultural vehicle, including the steps of generating a cultivation plan for the piece of farmland, which plan includes generating multiple paths that spatially extend over the piece of farmland along particular coordinates within the outer boundary, and after the plan has been generated, controlling the autonomous vehicle to cross the land by moving over each of the multiple paths, wherein the outer boundary is divided in one or more distinguished subsections based on one or more predetermined attributes such that each of the one or more subsections of the outer boundary is provided with a qualification that corresponds to the one or more predetermined attributes, and the particular coordinates for each of the multiple paths are established depending on the qualification of the one or more subsections of the outer boundary.

### GENERAL FIELD OF THE INVENTION

The present invention pertains to a method for cultivating a piece of farmland within an outer boundary of this piece of farmland using an autonomous agricultural vehicle for performing an agricultural operation to attain said cultivating, the method comprising generating a cultivation plan for the piece of farmland, which plan comprises generating multiple (in particular but not necessarily contiguous) paths that spatially extend over the piece of farmland along particular coordinates within the said outer boundary, and after the plan has been generated, controlling the autonomous vehicle such that it crosses the land by moving over each of the multiple paths. The invention also pertains to a method and system for generating a cultivation plan for such an autonomous vehicle.

### BACKGROUND ART

The adoption of technology in agriculture has improved the approaches that farmers use in the farmland nowadays. Modern agriculture has made it easy for farmers to achieve high produce while using less input, in particular less labour. According to the trends in the use of technology in agriculture, there are high concerns whether or not the future of agriculture is bright. For example, mechanization in agriculture has reduced the overuse of manpower in doing some of the farming activities. As a consequence, agricultural machines have become bigger and bigger and more dedicated towards performing one type of cultivation. The introduction of autonomous agricultural vehicles, such as an autonomous tractor that is operatively connected to an agricultural machine such as a plough, is considered a next step into the future of farming and it is expected that using autonomous vehicles there is more freedom to cultivate the land using even less labour.

Self-driving cars are common these days. Based on the trends in regards to the advancement of technology, it is expected that the technology will also be used on a wide scale for cultivating farmland. At present farmers in advanced countries are giving a tactical approach to how they plant, harvest, as well as maintain their crops. A good example of new tactical approaches is the use of autonomous vehicles in agriculture. The concept of autonomous vehicles (form now on also denoted as autonomous tractors) can be traced back prior to the introduction of the concept of precision farming in the eighties. During these days, farmers used GPS technology as a guide to the tractors driving across the farmland. The aim of such an approach was the reduction of fuel consumption and enhancing the efficiency of the tractors and the farming activities. As such, these initial steps formed the basis for the development of autonomous tractors, following the introduction of technologies that improved communication over wireless devices. Autonomous tractors employ much the same approach as the driverless vehicles, i.e. using advanced control systems and sensors. With the inclusion of auto-steering abilities, such tractors have added control abilities. Evidently, the launch of the autonomous tractors is considerably a manifestation of the extended use of this technology in farming.

Benefits to farmers are obvious. It is an undeniable fact that farming is not an easy undertaking, it involves working for long hours and the subscription to hard labour in harsh weather conditions. Taking into consideration the common state of farmers, the majority of them have no employees to task them in the farmland and hence, have to do everything all by themselves, the autonomous tractors obviously can be a positive outcome. Next to this, accuracy and precision are important aspects in agriculture in various aspects such as planting. All in all, the use of such tractors may lead to higher return on investment since accuracy is enhanced.

It is generally recognized that data plays a significant role in determining the farmers' decisions. Usually, the absence of clear and reliable data can interfere with the decisions farmers make, and subsequently, have adverse impacts on the amount of outcome obtained from the fields. There are diverse sources and types of data that a farmer needs to succeed in their farming activities. For example, data on soil is important in that it helps farmers in determining what crops will do well in a given piece of land by establishing the moisture content, and the amount of nutrients. The autonomous tractors can be fitted with various sensors that can be used in the collection of data on the conditions of the soil, and hence, offer a platform for improving the outcome of the available crops. The elimination of the human interaction in farming following the use of autonomous tractors may thus be advantageous. Stressed employees cannot achieve the required efficiency level in the fields. Similarly, it is often hard for humans to manage diverse tasks on the farm especially where a large farmland is involved. Autonomous tractors have the appropriate sensors to offer the necessary help in the management of a several tasks in the farmland hence reducing stress and the workload in the farm.

The autonomous tractors run on high level technology that can be used in gathering high profile information. For example, some models have automatic steering abilities and GPS technologies which enhance the control of the tractors' course. The advanced sensors come in handy in the determination of soil moisture level, activities around planting and harvesting, present yield, as well as the amount of fuel needed for a given area of land. Additionally, other models of autonomous tractors can guide farmers on how to apply fertilizers.

Autonomous tractors allow precise control of work and farm equipment. This makes it possible for farmers to extend their working hours. The sensors fitted in the tractors can guide it in the right course even in conditions of reduced visibility and at night: work continues even during windy, dusty, and foggy conditions. Additionally, the ability of the tractors to reduce workload and stress on employees comes in handy in increased working hours in a day since the farmer has a greater flexibility in the management of growing tasks.

It has thus become a common understanding that the best way for using an autonomous vehicle is to establish a cultivation plan for the piece of farmland, which plan comprises generating multiple paths that spatially extend over the piece of farmland along particular coordinates within the outer boundary of the piece of farmland, and after the plan has been generated, controlling the autonomous vehicle such that it crosses the land by moving over each of the multiple paths, Also, the way the actual agricultural machine (which may be part of the vehicle or coupled thereto) is operated (for example its driving speed, its height with respect to the land, its angle with respect to the land etc.), is controlled using the sensor technology to adapt the predetermined plan to the particular circumstances of the moment in time the land is actually cultivated. Such circumstances can for example be objects that were not present at the piece of land at the time the plan was made, the weather conditions, etc.

Typically, the paths extend such that the outer boundary of the piece of farmland is typically not crossed, at least not by the tractor itself. Various ways for implementing this are known from the prior art.

In U.S. Pat. No. 7,110,881 (Deere & Company) a perimeter training module establishes a perimeter path plan of a vehicle including a defined perimeter. A region-filling module establishes a region-filling path plan of the vehicle within the defined perimeter. A point-to-point planning module establishes a point-to-point path plan of a vehicle including a segment of at least one of the region-filling path plan and the perimeter path plan. The path planner forms a preferential composite path plan based on the established perimeter path plan, the region-filling plan, and the point-to-point path plan.

EP 2957159 (Claas KGaA) discloses a method for the determination of optimal driving lanes within a boundary of a piece of farmland, wherein in the method target lanes are determined in a piece of farmland for planning of an agricultural vehicle, with an inner field having a defined inner field boundary in a field area such that an edge surface results between a boundary contour of the field area and the inner field boundary, wherein in the inner field running target lanes are determined for the route planning. The method is characterized in that edge stretches are determined, which run in the edge surface along the boundary and that a determination of the edge surface and/or the edge stretches machine-specific features taken into account.

EP 3330824 (Precision Makers BV) discloses a method of autonomous path planning for a vehicle, comprising the steps of a) determining an outer boundary and an inner boundary of a working area for a vehicle to operate on, b) providing a direction parameter indicating a primary working direction along which the working area is to be worked on; c) providing an angle parameter indicating an angle between a secondary working direction and the primary working direction, wherein the secondary working direction indicates a direction along which a plurality of working paths are to be arranged within the inner boundary. The method further comprising the steps of d) calculating the plurality of working paths within the inner boundary based on the direction parameter and the angle parameter; and e) further calculating one or more connecting paths between the outer boundary and the inner boundary, each connecting path connecting two subsequent working paths.

U.S. Pat. No. 10,368,475 (Cropzilla Software Inc) discloses a method for determining the optimal machine working direction(s) of travel for a field boundary to be used in a guidance/navigation system for machine control, which includes using specific field boundary information and machine specific information to spatially simulate travel path estimates over a plurality of splayed working directions of travel to determine the optimal working direction(s) of travel for the field boundary. Optimizing the spatial field efficiency by simulating travel path estimates to select an optimal working direction(s) of travel may then be used in accordance with a machine's guidance and/or navigation system, via an information transfer system, as the reference working direction(s) of travel for the machine to guide and control itself while performing fieldwork.

EP 1840690 discloses a method of creating a routing plan for an autonomous agricultural vehicle wherein the routing plan is dynamically altered if a new implement is added to be used with the vehicle. Also, the method is able to take into account the spatial arrangement of a contiguous plot and adapt the plan thereto. As described, in case of a road or forest neighbouring the farmland to be cultivated, a safety zone is created in the piece of farmland in which zone the autonomous mode is either limited or completely left, such that a human operator can have at least part of the control. Downside is that an operator is needed to stand-by.

GB 2543146 also discloses a system for planning a routing for an autonomous vehicle, comprising a guidance module that uses predefined geo-fenced guidance line data to ultimately rank or prioritize the potential guidelines. These can then be displayed to the vehicle operator for operator selection. This technique recues the amount of skill and interaction needed by the operator for producing the most efficient path plans to avoid unnecessary fuel consumption, increased travel distances, excessive vehicle turns or increase vehicle operation. The method at least partly depends on operator input.

EP 3907469 discloses a method for path planning that at least partly depends on identifying boundaries of the land to be cultivated. In particular, it is checked whether a specific area identified automatically by the system is consistent with previous area boundary ranges in order to increase reliability.

Although various methods to take the boundary of a field into account when determining the cultivation plan are known, there is room for improvement.

### OBJECT OF THE INVENTION

It is an object of the invention to devise an improved method for cultivating a piece of farmland within an outer boundary of this piece of farmland.

### SUMMARY OF THE INVENTION

In order to meet the object of the invention, a method as described here above in the General Field of the Invention section has been devised, the method being improved in that in the method the outer boundary is divided in one or more distinguished subsections based on one or more predetermined attributes such that each of the one or more subsections of the outer boundary is provided with a qualification that corresponds to the one or more predetermined attributes, and in that in the method the particular coordinates for each of the multiple paths are established depending on the qualification of the one or more subsections of the outer boundary.

The invention started off with the recognition that the boundary may have different qualifications along its length. This means that different subsections of the boundary may have different properties and thus can be differently qualified, depending on predetermined attributes, i.e. characteristic features such as the local quality of the land, the shape of the boundary (straight, heavily curved, etc), the local slope, the presence of items on the outer side of the boundary (outside if the piece of farmland) etc. The inventors realised that the choice of the attribute or attributes based on which the boundary is qualified along its length, and potentially divided in multiple subsections each having a particular qualification, does not need to be a fixed set of attributes, but may vary depending on local preferences, local legislation, the type of agricultural machine, personal preferences of a person overseeing the provision of the cultivation plan, etc. In any case, by applying a set of one or more predetermined attributes and thereby dividing the outer boundary in one or more distinguished subsections, a cultivation plan can be made that takes these different qualifications into account. This way, the particular coordinates for each of the multiple paths are established depending on the qualification of the one or more subsections of the outer boundary. Although the invention pertains in essence to the paths that are adjacent the boundary of the piece of farmland, indirectly the complete plan (in essence covering the whole of the piece of farmland as intended to be worked upon), i.e. the complete length of all paths, depends on this qualification. This is because each path along the outer boundary ultimately will have an effect on the coordinates of its neighbouring path towards the centre of the piece of farmland, which on its turn has an effect on the coordinates of the following neighbouring path etc.

The invention is also embodied in a method for generating a cultivation plan for an autonomous agricultural vehicle for cultivating a piece of farmland within an outer boundary of this piece of farmland, the method comprising determining multiple paths that spatially extend over the piece of farmland along particular coordinates within the said outer boundary, wherein in the method the outer boundary is divided in one or more distinguished subsections based on one or more predetermined attributes such that each of the one or more subsections of the outer boundary is provided with a qualification that corresponds to the one or more predetermined attributes, and in that in the method the particular coordinates for each of the multiple paths are established depending on the qualification of the one or more subsections of the outer boundary.

The invention is also embodied in a system for generating a cultivation plan for an autonomous agricultural vehicle for cultivating a piece of farmland within an outer boundary of this piece of farmland, the system comprising a processing unit to a) determine multiple paths that spatially extend over the piece of farmland along particular coordinates within the said outer boundary, and b) to divide the outer boundary in one or more distinguished subsections based on one or more predetermined attributes such that each of the one or more subsections of the outer boundary is provided with a qualification that corresponds to the one or more predetermined attributes, and c) to determine the particular coordinates for each of the multiple paths depending on the qualification of the one or more subsections of the outer boundary.

### DEFINITIONS

A tractor is an agricultural vehicle that is used cultivate land, typically by pulling or carrying agricultural machinery, and to provide the energy needed for the machinery to cultivate the land. It commonly, but not necessarily, is a powerful vehicle with a gasoline or electric engine and large rear wheels or endless belt tracks (so called caterpillar tracks).
An autonomous vehicle is a vehicle that can move over a piece of land according to a predetermined cultivation plan without a human operator controlling its movement. Such a vehicle can automatically perceive its environment, make decisions based on what it perceives and recognizes, and then actuate a movement or manipulation within that environment. These decision-based actions may include, but are not limited to, starting, stopping, and maneuvering around obstacles that are in its way. Such a vehicle can cross farmland without needing continuous control of a human operator, and thus is able to autonomously cultivate the land.
Farmland is land that is used for or suitable for farming.
An outer boundary of a piece of farmland is the perimeter or border (i.e. the continuous line forming the boundary) of the piece of farmland, therewith defining the shape and location of the piece of farmland.
The spatial arrangement of a plot of land is the way the land is provided with natural or artificial items (such as buildings, waterways, plants, roads, other infrastructure etc.) and the spatial property of the way in which these items are arranged with respect to each other in this plot.
To qualify an item is to establish an attribute for that item, viz. to establish a quality or feature regarded as a characteristic of this item.
Contiguous means touching along a boundary, not excluding that there is overlap.
An operator of a machine or device is a human person that is trained to control this machine or device.
A cultivation plan for a tractor to cultivate a piece of land, is a plan which defines at least the position, direction and speed of the corresponding agricultural vehicle when crossing the land such that the land in essence can be cultivated completely.
Automatic means without the need of (human) operator intervention. The term automatic does not exclude that something is operator initiated or operator stopped as long the process can be completed without needing operator intervention.

### EMBODIMENTS OF THE INVENTION

In a first further embodiment of the method for cultivating a piece of farmland according to the invention, the one or more attributes are chosen from the group that comprises or consists of 1) a spatial arrangement of a plot that is contiguous with the piece of farmland (i.e. a plot that shares the outer boundary with the piece of farmland), 2) a quality of the land at the outer boundary (quality for driving, quality for crop growing, etc), and 3) a shape of the farmland at the outer boundary (the shape being either the shape of the footprint of the land (i.e. how curvy the boundary is) of the local slope adjacent the boundary). It was found that these three attributes are the most prominent ones for any boundary of a piece of farmland to have a significant influence on the proper cultivation of the land, i.e. to avoid any cultivation faults, time consuming interruptions, unsafe situations, accidents etc.

In a preferred embodiment hereof, the attribute is the spatial arrangement of a plot that is contiguous with the piece of farmland. The inventors recognised that the spatial arrangement of a plot that is outside of the piece of farmland may advantageously be taken into account for generating the cultivation plan. This seems odd since the area outside of the piece of farmland, in particular its spatial arrangement, at first glance seems irrelevant for the design of a cultivation plan for the piece of farmland that is within the boundary, but it is not: For example, when a road is present directly along the boundary, it is of the utmost importance that no part of the vehicle or its machine at any time crosses the outer boundary. For a ditch, or other piece of farmland it would be no problem that a vehicle turns near the boundary whereby for example it plough swings over the ditch or neighbouring land, but for a road this would be unacceptable. The same way, if a piece of farmland is at one part of the boundary neighboured by a residential area, the production of noise can be taken into account to meet local legislation. Turning at a border produces more noise than driving along a border for example. In any case, it has been recognised that it is advantageous to take the spatial arrangement of a plot next to the piece of farmland into account for providing the cultivation plan.

Preferably, the attribute is the spatial arrangement in an area that covers 100 metres or less in the said plot from the outer boundary, even more preferably an area that covers 50 metres or less in the said plot from the outer boundary, or in the alternative 40, 30, 20, 19, 18, 17, 16, 15, 14, 13, 12, 11, 10, 9, 8, 7, 6, 5, 4, 3, 2, 1 metre or less.

The inventors recognised that it is in particular advantageous that a spatial arrangement assessed in the method is chosen from the group that comprises or consists of a) the presence of buildings, in particular residential buildings, b) the presence of a road, c) the presence of a waterway, d) the presence of other farmland, and e) the presence of protected area such as protected natural area, or protected military area etc.).

In a further embodiment, in which embodiment the multiple paths are crossed in a predetermined order, the predetermined order also (i.e. next to the particular coordinates for each of the multiple paths) depends on the qualification of the one or more subsections of the outer boundary. This pertains to fine tuning of the method wherein not only the lay-out of the paths over the farmland depends on the qualification of the one or more subsections of the outer boundary, but also the order in which these paths are crossed during the actual cultivation of the piece of farmland.

Preferably, the autonomous agricultural vehicle comprises an autonomous tractor and operatively coupled thereto an agricultural machine that performs the agricultural operation. The machine can be chosen from a group of multiple different agricultural machines. The method can be adapted to each of these different machines, in particular to the load needed to perform the respective agricultural operation for each of these machines.

It is noted that any and all embodiments as described here above or exemplified here after in the examples section for the method for cultivating a piece of sloping farmland can also be embodied in the method for generating a cultivation plan for an autonomous agricultural vehicle according to the invention, and in the system according to the invention.

The invention will now be further illustrated using the following specific examples.

### EXAMPLES OF THE INVENTION

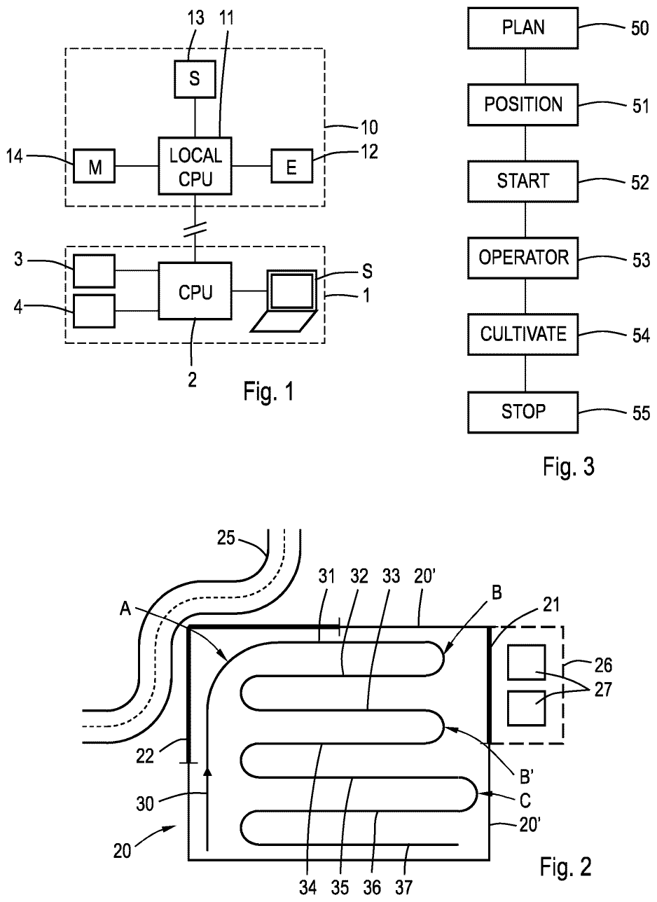

FIG. 1 schematically shows a system according to the invention.

FIG. 2 schematically shows a piece of farmland having and outer boundary that is divided in multiple distinguished subsections and a cultivation plan for this farmland.

FIG. 3 is a flow diagram describing a method according to the invention.

### FIG. 1

FIG. 1 schematically shows a system 1 according to the invention. The system 1 has a central processing unit 2, that is operatively connected (wireless) to local processing unit 11 of vehicle 10 (schematically depicted as a dashed box). Note that any connection between electronic components as indicated in FIG. 1 can be wired or wireless as commonly known in the art. The system 1 further comprises a unit 3 that holds data regarding a piece of land to be cultivated (see FIG. 2), such as the GPS coordinates (in three dimensions), the type of soil, objects in the piece of land, etc. and importantly, the spatial arrangement of all contiguous plots in the first 50 meters within an outer boundary section.

In particular, based on the spatial arrangement data and the attributes of “residential area, Y of N”, “road within 5 meters of border, Y of N”, the outer boundary is divided in one or more distinguished subsections. If a residential area is present along a subsection, that section of the boundary is qualified as “Residential”. If a road is present as indicated here above, the qualification is “Road”. If no houses or road is present, the qualification is “No restrictions”. Unit 4 comprises data regarding the (estimated) weather conditions and other conditions that apply during the period of time planned for cultivating the land. The CPU is connected to a computer 5 (“S” in FIG. 1) that can be used by a human operator to input various data needed for planning the cultivation of the piece of farmland. This process as such is known from the art. For example, a process as described in US2020033143 in conjunction with FIGS. 6-11 therein. This way, the system 1 is able to generate a cultivation plan for the vehicle 10, taking into account all data, in particular the data regarding the qualification of each subsection of the boundary (see also FIG. 2).

For the actual operation to perform this plan, the local processing unit of vehicle 10 is connected to engine 12 and steering unit 13. The cultivation plan as generated by system 1 is stored in unit 14 and may be adapted when needed by information provided via CPU 2 of the system. The local processing unit 11 is able to let the vehicle perform this plan via control of the engine 12 and steering unit 13.

The generation of the cultivation plan comprises the determination of multiple paths that extend over the piece of farmland (see FIG. 2), an order in which the paths are to be crossed by the autonomous vehicle, and to the direction of movement of the vehicle on each of said multiple paths. According to the invention, the direction of movement of the autonomous vehicle over each of the paths depends on the qualification of subsections of the outer boundary 20 of the piece of farmland. In more detail, based on the available information, the CPU 2 receives data regarding the boundary section as received via unit 3, and generates a travel route that fits to this field and the qualifications of its outer boundary. This travel route may be generated automatically based on basic, initial parameters entered via units 3 and 4, and/or based on input parameters substantially defining a travel route entered by an operator via computer 5.

### FIG. 2

FIG. 2 schematically shows a piece of farmland having and outer boundary 20 that is divided in multiple distinguished subsections 20, 21 and 22, and a cultivation plan for this farmland, in which plan an autonomous tractor with a plough us used for ploughing the land. As described here above with reference to FIG. 1, the boundary 20 is divided into multiple subsections based on the attributes “residential area, Y of N”, “road within 5 meters of border, Y of N”. In the case as indicated, section 21 is qualified as “Residential” due to the fact that the piece of farmland is locally adjacent to residential area 26 comprising multiple flat buildings 27. Section 22 is qualified as “Road” due to the fact that within 5 meters of the boundary 20 a road 25 is present along this section. Note that the section 22 is extended at its edges for at least 5 meters away from the road 25.

The cultivation plan 30 includes multiple (in these case contiguous) paths 30 to 37 (each section before a turn of curve is indicated as a “path”) are established depending on the qualification of the subsections of the outer boundary: paths 30 runs in parallel with section 22 to make absolutely sure that no part of the tractor or plough crosses (respectively swings over) section 22. The same is true for path 31. At the crossing of these paths, at position A, the particular coordinate is removed substantially far from the section 22 to make sure the plough does not swing one bit over section 22 when the tractor makes the turn from path 30 to path 31. Also, at outer position B where paths 31 and 32 cross, the distance to the section 21 is far enough to prevent that the plough does not swing one bit over section 21 (where people could be present). The same ss true for the corresponding position B′ where paths 33 and 34 cross. As can be seen, since section 20′ has the qualification “No restrictions”, the particular coordinates of position C where paths 35 and 26 cross are substantially more close to the outer boundary 20 that at positions B and B′. At this turn namely, the plough is allowed to swing over the boundary which means that the tractor is allowed to make its turn closer to the boundary.

### FIG. 3

FIG. 3 is a flow diagram describing a method according to the invention. In step 50, a cultivation plan is established to cultivate a piece of farmland, in line with what was described before in conjunction with FIGS. 1 and 2. In the next step 51, a tractor coupled to an agricultural machine for autonomously performing the plan is positioned on the piece of land (at the beginning of path 30; see FIG. 2). The tractor is started in step 52 and operates according to the cultivation plan provided by the system according to the invention (see FIG. 1). Then, optionally, for the purpose of fine-tuning the operation, in step 53 an operator comes near the tractor. This enables the operator to assess the actual performance of the cultivation to assess whether this in in line with the cultivation plan and if needed, to adapt this cultivation plan, for example to improve the quality of the cultivation and/or positioning of the tractor and its machine on the piece of farmland during the cultivation (for example of due to the conditions of the land or weather, there is a risk that the boundary will be crossed by the machine, even if for a very small length). Thereafter, the tractor cultivates the piece of land in step 54 according to the cultivation plan (potentially as adapted by the human operator) until the whole piece of land is cultivated according to this plan. Ultimately, the tractor is stopped in step 55, and can be picked up to bring to another piece of farmland.

What is claimed is:

1. A method for cultivating a piece of farmland within an outer boundary of this piece of farmland using an autonomous agricultural vehicle for performing an agricultural operation to attain said cultivating, the method comprising the steps of:
generating a cultivation plan for the piece of farmland, which step comprises the step of generating multiple paths that spatially extend over the piece of farmland along particular coordinates within the said outer boundary, and
after the plan has been generated, controlling the autonomous vehicle such that it crosses the land by moving over each of the multiple paths,
wherein the step of generating a cultivation plan further includes the steps of:
dividing the outer boundary into one or more distinguished subsections based on one or more predetermined attributes such that each of the one or more subsections of the outer boundary is provided with a qualification that corresponds to the one or more predetermined attributes, and
establishing the particular coordinates for each of the multiple paths depending on the qualification of the one or more subsections of the outer boundary.

2. A method according to claim 1, wherein the step of dividing includes the step of choosing the one or more attributes from the group that comprises a spatial arrangement of a plot that is contiguous with the piece of farmland, a quality of the land at the outer boundary, and a shape of the farmland at the outer boundary.

3. A method according to claim 2, wherein the attribute is the spatial arrangement of a plot that is contiguous with the piece of farmland.

4. A method according to claim 3, wherein the attribute is the spatial arrangement in an area that covers 100 metres or less in the said plot from the outer boundary.

5. A method according to claim 4, wherein the attribute is the spatial arrangement in an area that covers X metres or less in the said plot from the outer boundary, wherein X is one of 50, 40, 30, 20, 19, 18, 17, 16, 15, 14, 13, 12, 11, 10, 9, 8, 7, 6, 5, 4, 3, 2, and 1 metre or less.

6. A method according to claim 2, wherein the spatial arrangement assessed in the method is chosen from the group that comprises a) the presence of buildings, b) the presence of a road, c) the presence of a waterway, d) the presence of other farmland, and e) the presence of a protected area.

7. A method according to claim 1, wherein the multiple paths are crossed in a predetermined order, and the predetermined order also depends on the qualification of the one or more subsections of the outer boundary.

8. A method according to claim 1, wherein the autonomous agricultural vehicle comprises an autonomous tractor and operatively coupled thereto an agricultural machine that performs the agricultural operation.

9. A method for generating a cultivation plan for an autonomous agricultural vehicle for cultivating a piece of farmland within an outer boundary of this piece of farmland, the method comprising the steps of:
determining multiple paths that spatially extend over the piece of farmland along particular coordinates within the said outer boundary,
dividing the outer boundary into one or more distinguished subsections based on one or more predetermined attributes such that each of the one or more subsections of the outer boundary is provided with a qualification that corresponds to the one or more predetermined attributes, and
establishing the particular coordinates for each of the multiple paths depending on the qualification of the one or more subsections of the outer boundary.

10. A system for generating a cultivation plan for an autonomous agricultural vehicle for cultivating a piece of farmland within an outer boundary of this piece of farmland, the system comprising:
a processing unit:
a) to determine multiple paths that spatially extend over the piece of farmland along particular coordinates within the said outer boundary,
b) to divide the outer boundary into one or more distinguished subsections based on one or more predetermined attributes such that each of the one or more subsections of the outer boundary is provided with a qualification that corresponds to the one or more predetermined attributes, and
c) to determine the particular coordinates for each of the multiple paths depending on the qualification of the one or more subsections of the outer boundary.
